(19) United States
(12) Patent Application Publication
(10) Pub. No.: US 2021/0089077 A1
(43) Pub. Date: Mar. 25, 2021

(54) DEPLOYABLE FEET FOR DISPLAY ARTICULATION AND THERMALS PERFORMANCE

(71) Applicant: Apple Inc., Cupertino, CA (US)

(72) Inventors: Paul X. Wang, Cupertino, CA (US); Keith J. Hendren, San Francisco, CA (US)

(21) Appl. No.: 16/785,394

(22) Filed: Feb. 7, 2020

Related U.S. Application Data
(60) Provisional application No. 62/904,447, filed on Sep. 23, 2019.

(51) Int. Cl. G06F 1/16; G06F 1/20

(52) U.S. Cl. CPC G06F 1/166; G06F 1/1601; G06F 1/1667; G06F 1/203; G06F 1/1616

(57) ABSTRACT

An electronic device can include a base portion, a display portion rotatably mounted to the base portion, and a deployable feature. The deployable feature can be deployed from a surface of the base portion by an actuation component coupled to the deployable feature. The deployable feature can support the electronic device, increase clearance above a support surface for one or more portions of the electronic device, and/or allow additional functionality for the electronic device.

### CROSS-REFERENCE TO RELATED APPLICATION(S)

This claims priority to U.S. Provisional Patent Application No. 62/904,447, filed 23 Sep. 2019, entitled “DEPLOYABLE FEET FOR DISPLAY ARTICULATION AND THERMALS PERFORMANCE,” the entire disclosure of which is hereby incorporated by reference.

### FIELD

The described examples relate generally to components of electronic devices. More particularly, the present disclosure relates to deployable features of an electronic device.

### BACKGROUND

Electronic devices can have multiple portions that can move relative to one another and can allow for multiple device configurations. For example, a laptop computing device can have a display portion moveably mounted to a base portion. The display portion can rotate or be movable in relation to the base portion by a hinge that couples the base portion to the display portion. For example, many laptop computers have a display portion that rotates around a hinge assembly to facilitate viewing of a display in the display portion at various viewing angles, and to allow access to user input controls located on the base portion.

One challenge associated with such electronic devices can be ensuring that the display portion has sufficient clearance to rotate. For instance, many laptop computers are designed to have a base portion positioned on a support surface, such as a table. Certain designs of electronic devices allow for the edge of the display portion that is proximate the hinge to rotate below the bottom of the base portion. Thus, when proper clearance from the support surface is not provided for the edge of the display portion, the edge can contact the support surface, potentially damaging the display portion and/or the support surface. Further, contact between the display portion and the support surface can limit the viewing angle of the display portion. Structures affixed to the base portion that can provide sufficient clearance can be bulky and can increase the overall size of the device. Thus, there exists a demand for components and methods that provide sufficient clearance for a moveable display portion, while also minimizing the size of such components.

Another challenge faced by electronic devices is providing sufficient space within the device housing for various components. There is a strong demand for electronic devices, especially portable electronic devices, such as laptop computers, to be thin and lightweight while simultaneously including numerous features delivering high performance. As the number and performance of internal components increases, so do thermal and other demands on the electronic device. Thus, there exists a demand for efficient usage of space within an electronic device, and efficient means of cooling the device. Accordingly, it can be desirable for an electronic device to include deployable features that can both increase clearance of the base portion and also improve the efficiency of the internal volume of the base portion, while maintaining a portable and sleek form factor.

### SUMMARY

According to some examples of the present disclosure, an electronic device includes a base portion, a display portion rotatably mounted to the base portion, a deployable feature coupled to the base portion that extends at least 3.8 millimeters from a surface of the base portion when deployed, and an actuation component coupled to the deployable feature. The base portion can include a portion of a housing of the electronic device and a keyboard.

The deployable feature can, when deployed, increase an open area in communication with an internal volume defined by the base portion. The deployable feature can at least partially define an air volume when deployed. The air volume can be usable by an antenna or a speaker. In some examples, rotating the display portion relative to the base portion deploys the deployable feature. The actuation component can include a gear train. The deployable feature can be deployable by a user. The deployable feature can at least partially define a vent when deployed.

In some examples, the electronic device includes a sensor that provides a signal to deploy the deployable feature. The actuation component can include at least one of a pneumatic, a magnetic, a piezo friction, or an electro-mechanical system. The deployable feature can include a support structure.

According to some examples, a method for deploying a deployable feature of an electronic device includes detecting a condition of the electronic device, and deploying the deployable feature in response to the detected condition. Detecting the condition can include receiving an input from an input member of the electronic device. Detecting the condition can include detecting a rotation of a display portion of the electronic device relative to a base portion of the electronic device. Deploying the deployable feature can include extending the feature a distance away from a base portion of the electronic device

According to some examples, an electronic device includes a base portion, a display portion moveably affixed to the base portion, and a deployable feature coupled to the base portion and deployable therefrom in response to a signal. The deployable feature can deploy vertically from the base portion. The electronic device can include a sensor that detects at least one of a temperature or a processing speed of the electronic device, and provides the signal in response to the detection. The electronic device can further include a fan, wherein a speed of the fan is at least partially based on a state of the deployable feature.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of an electronic device.

FIG. 2A shows a side view of the electronic device of FIG. 1 in a closed position.

FIG. 2B shows a side view of the electronic device of FIG. 2A in an open position.

FIG. 3A shows a side view of an electronic device including a deployable feature.

FIG. 3B shows a side view of the electronic device of FIG. 3A.

FIG. 4A shows a side view of an electronic device including a deployable feature.

FIG. 4B shows a perspective view of an electronic device including a deployable feature.

FIG. 5 shows a cross-sectional side view of an electronic device including a deployable feature.

FIG. 6A shows a cross-sectional side view of an electronic device including a deployable feature in an un-deployed state.

FIG. 6B shows a cross-sectional side view of the electronic device of FIG. 6A with the deployable feature in a deployed state.

FIG. 7A shows a cross-sectional side view of an electronic device including a deployable feature in an un-deployed state.

FIG. 7B shows a cross-sectional side view of the electronic device of FIG. 7A with the deployable feature in a deployed state.

FIG. 8 shows a side view of an electronic device including a deployable feature.

FIG. 9 shows a perspective view of an electronic device including a deployable feature.

FIG. 10A shows a cross-sectional side view of an electronic device including a deployable feature in an un-deployed state.

FIG. 10B shows a side view of the electronic device of FIG. 10A with the deployable feature in a deployed state.

FIG. 11A shows a perspective view of an electronic device including a deployable feature in an un-deployed position.

FIG. 11B shows a perspective view of the electronic device of FIG. 11A with the deployable feature in a deployed position.

FIG. 12 shows a cross-sectional side view of an electronic device including a deployable feature.

FIG. 13 shows a cross-sectional side view of an electronic device including a deployable feature.

FIG. 14 shows a cross-sectional side view of an electronic device including a deployable feature.

FIG. 15 shows a cross-sectional side view of an electronic device including a deployable feature.

FIG. 16A shows a cross-sectional side view of an electronic device including a deployable feature in an un-deployed position.

FIG. 16B shows a cross-sectional side view of an electronic device including a deployable feature in a deployed position.

FIG. 17A shows a side view of an electronic device including a deployable feature in an un-deployed position.

FIG. 17B shows a side view of an electronic device including a deployable feature in a deployed position.

FIG. 18A shows a bottom rear perspective view of an electronic device including a deployable feature in a deployed position.

FIG. 18B shows a bottom rear perspective view of the electronic device of FIG. 16A with the deployable feature in an un-deployed position.

FIG. 19 shows a side view of an electronic device including a deployable feature.

FIG. 20 shows a side view of an electronic device including a deployable feature.

FIG. 21 shows a top view of an electronic device including a deployable feature.

FIG. 22 shows a rear view of an electronic device including a deployable feature.

FIG. 23 shows a rear view of an electronic device including a deployable feature.

FIGS. 24-30 show bottom views of electronic devices including deployable features.

FIG. 31 shows a process flow diagram of a process for deploying deployable features.

### DETAILED DESCRIPTION

Reference will now be made in detail to representative examples illustrated in the accompanying drawings. It should be understood that the following descriptions are not intended to limit the examples to one preferred embodiment. To the contrary, it is intended to cover alternatives, modifications, and equivalents as can be included within the spirit and scope of the described examples, as defined by the appended claims.

Many electronic devices, such as laptop computers, are designed to be placed on a support surface, such as a table or desk, with a base portion of the electronic device being adjacent to, and generally parallel with, the support surface. Certain designs of electronic devices allow for an edge of the display portion that is proximate a hinge that connects to the base portion to rotate below a bottom surface of the base portion. When sufficient clearance is not provided between the base portion and the support surface for the edge of the display portion, the edge can contact the support surface, potentially damaging the display portion and/or the support surface. Further, contact between the display portion and the support surface can limit the viewing angle of the display portion because rotational motion of the display portion can be stopped by the support surface.

Another challenge faced by electronic devices is providing sufficient space within the device housing for a desired number of components in order to achieve desired levels of performance. There is a strong demand for electronic devices, especially portable electronic devices, such as laptops, to be thin and lightweight, while simultaneously including numerous features delivering high performance. As the number and performance of internal components increases, so do the demands on the electronic device (e.g., high operating temperatures). Thus, there exists a demand for efficient usage of space within a housing of an electronic device, and for efficient ways of cooling the device. Accordingly, it can be desirable to construct an electronic device including deployable features. These deployable features can both increase clearance of the base portion to allow for movement or motion of one or more portions relative thereto, and can provide additional volume or space that can be utilized by one or more components of the base portion.

In some examples, an electronic device can include a base portion, a display portion rotatably mounted to the base portion, and a deployable feature coupled to the base portion that extends from a surface of the base portion when deployed. An actuation component coupled to the deployable feature can cause the deployable feature to deploy and retract from the base portion. The base portion can include a portion of a housing of the electronic device and a keyboard. The deployable feature can function as a support structure for the electronic device when deployed.

In some examples, an electronic device including two portions that are moveable relative to one another can have an open position and a closed position. The electronic device can be designed to occupy space above a support surface with an edge of a display portion when in an open position. The electronic device can be considered to be in an open position when the display portion is rotated or moved away from a base portion such that the display portion is no longer substantially parallel with the base portion, or contacting the base portion at locations other than the location or locations of attachment. As discussed above, as the display portion is rotated open, the edge of the display portion can rotate below a plane defined by or aligned with a surface of the base portion, such as the bottom surface.

In some examples, an electronic device can include a deployable feature. In some examples, the deployable feature can function, in whole or in part, as a foot, a stand, and/or another support structure for the base portion and/or the electronic device. In some examples, the deployable feature can provide additional or alternative functionalities, as described herein, such as acting as a vent or open area for components of the electronic device. The deployable feature can be disposed on or within the base portion. For example, the deployable feature can be recessed or housed at least partially within an internal volume defined, at least partially, by the base portion. In some examples, the deployable feature can be positioned on a side or sides, or on a bottom surface of the base portion. The deployable feature can extend or deploy from the base portion, for example, to provide additional clearance between the base portion and a support surface for an edge of the display portion to move therethrough. The deployable feature can include an actuation component. The actuation component can deploy and/or retract at least a portion of the deployable feature from the base portion. In some examples, the actuation component can include one or more actuators to deploy and/or retract the deployable feature, including, but not limited to, gear trains, pulleys, chains, levers, four-arms, push-turn buttons, threads, piezoelectric actuators, pneumatic actuators, and/or magnetic actuators. A more detailed discussion of examples of actuation components used in concert with a deployable feature is discussed below.

In some examples, the deployable feature can raise or lift the electronic device by pushing against a support surface to increase a separation distance between the base portion and the support surface. The increased separation distance can, in turn, provide clearance for an edge or other portion of the display portion to rotate or move as it opens. In other words, the distance the deployable feature extends from the bottom surface of the base portion can be greater than the distance that the edge or other portion of the display portion extends past the bottom surface of the base portion when in an open state. The deployable feature can be made from a variety of desired materials. In some examples, the deployable feature can include one or more of metal, polymeric, and/or ceramic materials. In some examples, the actuation component includes metal and/or plastic and a foot or a pad of the deployable feature (meant to contact the support surface) includes from rubber.

The deployable feature can deploy from the base portion in response to a wide variety of events, signals, and/or states. In some examples, the deployable feature can deploy when the electronic device is in an open position. In some examples, deployment of the deployable feature depends on the angle between the display portion and the base portion. In some examples, the deployable feature can deploy in response to movement of the display portion, such as when the display portion is being rotated into an open position. In some examples, an actuation member can translate rotational motion of the display portion into linear motion of the deployable feature. In some examples, the deployment feature deploys when an operating condition of the electronic device occurs. In some examples, the deployable feature deploys in response to detection of a temperature or a processing speed of the electronic device, such as a detection of a temperature or processing speed above a desired threshold. In some examples, the deployable feature deploys in response to a user input on an input member (e.g., on/off switch or keypress). In some examples, there can be a dedicated input member for deploying one or more deployable features. In some examples, the deployable feature is configured to be deployed manually in response to physical force from a user applied to the deployable feature, such as by pushing, pulling, sliding, rotating, and other forces.

Likewise, once in a deployed positioned, the deployable feature can retract back toward the base portion (to an un-deployed position) in response to a wide variety of events, states, signals, and/or forces. In some examples, the deployable feature can retract when the electronic device is in a closed position. In some examples, the deployable feature can retract based on the angle between the display portion and the base portion, for example, when the angle is an acute angle. In some examples, the deployable feature can retract when the display portion is rotated toward a closed position. In some examples, an actuation member can translate rotational motion of the display portion into linear motion of the deployable feature to retract the deployable feature. In some examples, the deployable feature retracts when an operating condition of the electronic device occurs. In some examples, the deployable feature retracts in response to a detection of a temperature or a processing speed of the electronic device, such as a detection of a temperature or processing speed above a desired threshold. In some examples, the deployable feature retracts in response to a user input on an input member (e.g., on/off switch or keypress). In some examples, the deployable feature can retract in response to a physical force applied to the deployable feature, such as pushing, pulling, sliding, rotating, and/or other forces. In some examples, a seal or a protective cover can be used to block dust and debris from entering any gaps or openings formed between the base portion and the deployable feature. It will be understood that in some examples, the deployable feature can deploy and/or retract independent of the state or position of the device, such as if the electronic device is in a closed position (i.e., the edge is not below the bottom surface). Further details of the methods and conditions for retracting the deployable feature are provided below.

In some examples, the deployable feature can, when deployed, increase an open area in communication with an internal volume defined by the base portion. The deployable feature can, when deployed, at least partially define an air volume. The air volume can be usable by an antenna, a speaker, and/or any other internal component. For instance, the deployable feature can at least partially define a vent when deployed, the vent being in fluid communication with internal components of the electronic device disposed within an internal volume defined by the housing of the device. Further, internal components of the electronic device can utilize, such as by expanding or re-positioning, the volume which the deployable feature occupies when in an un-deployed (not deployed) state. The deployable feature can deploy to reveal an input/output port, or can itself define an input/output port. The deployable feature can reveal or define additional desired components/features, such as a light source, a button, a switch, and other components of the electronic device. In some examples, a seal or a protective cover can be used to block or inhibit dust and debris from entering any gaps or openings formed between the base portion and the deployable feature. A more detailed description of the various functions and uses of the deployable features is included below.

In the description herein, the terms “first portion,” “display portion,” and “upper portion” can refer to a lid portion of a computing device. Generally, a lid portion of a computing device is configured to be in a substantially upright position for a user to view a display housed in the lid portion while the device is being operated. In some examples, however, the lip portion can assume any desired position relative to the base portion. In the description below, the terms “second portion,” “main housing,” “base portion,” and “lower portion” can refer to a base of a computing device that can be moveably affixed to the lid portion and that generally includes connections to input components for user interaction with the computing device.

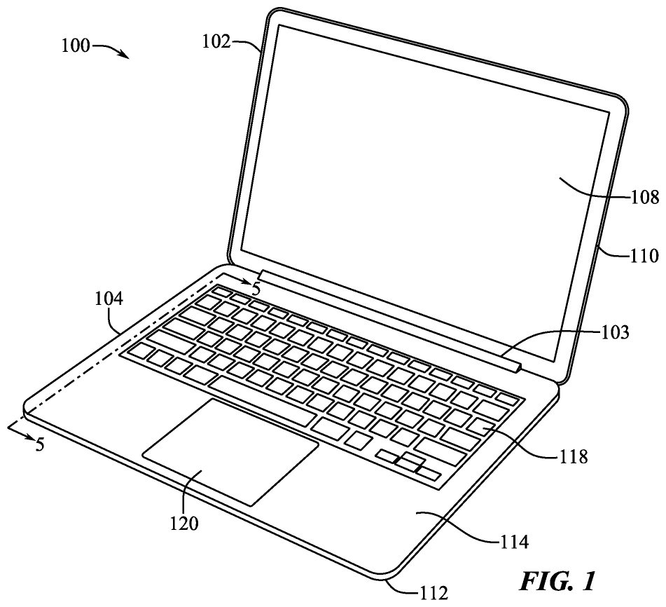

These and other examples are discussed below with reference to FIGS. 1-31. However, those skilled in the art will readily appreciate that the detailed description given herein with respect to these Figures is for explanatory purposes only and should not be construed as limiting.

FIG. 1 shows a front-facing perspective view of an electronic device 100. The electronic device 100 can be a laptop computer or a notebook computer, but this is merely one representative example of a device according to the present disclosure. The electronic device 100 can, for example, correspond to a portable media player, a media storage device, a portable digital assistant (“PDA”), a tablet computer, a computer, a mobile communication device, a GPS unit, a remote control device, and other similar electronic devices. The electronic device 100 can be referred to as an electronic device, or a consumer device. The electronic device 100 can include a housing having a base portion 104, which can be moveably, pivotally, or rotatably connected or affixed to a display portion 102, for example, by way of a hinge assembly 103. The display portion 102 and the base portion 104 can be referred to as different sections or portions of a single housing of the electronic device 100. The display portion 102 can pivot or otherwise move with respect to the base portion 104 from a closed position to an open position and back again with the aid of the hinge assembly 103. Although illustrated as being pivotally attached to the base portion 104, in some examples, the display portion 102 can move in any manner desired relative to the base portion 104. For example, the display portion 102 can laterally slide relative to the base portion 104. In some examples, the display portion 102 can move in any combination of directions relative to the base portion 104. For example, the display portion 102 can be rotated relative to the base portion 104, and/or can slide laterally relative to the base portion 104.

In the closed position, the display portion 102 can be positioned substantially on top of or over at least a portion of a top surface 114 of the base portion 104. In some examples, the display portion 102 can directly contact the top surface 114 of the base portion 104. In some examples, the display portion 102 can be substantially parallel to the top surface 114 of the base portion 104 when in the closed position. In the open position, the display portion 102 can be positioned at an angle relative to the top surface 114 of the base portion, for example, generally perpendicular to the top surface 114 of the base portion 104. In some examples, in an open position, the display portion 102 and the base portion 104 can form a generally obtuse angle. In some examples, the electronic device 100 can still be considered to be in an open position when an angle of less than 90 degrees is formed between the display portion 102 and the base portion 104.

The base portion 104 can further define a bottom surface 112 that can be disposed opposite the top surface 114. In some examples, the base portion 104 can include various user input devices such as a keyboard 118 and a touchpad 120, which can, for example, receive finger gesturing input from a user. In some examples, one or more of the input components 118, 120 can at least partially define the top surface 114, and can at least partially be positioned in an aperture or apertures defined by the base portion 104. The base portion 104 and the display portion 102 can each define internal volumes, chambers, or cavities that house internal components of the electronic device 100. The display portion 102 can further define an aperture or an opening, and can include a display 108 disposed therein. In some examples, the display portion 102 can include a rear housing or a rear cover 110 that can be disposed opposite the aperture and/or the display 108. Thus, the display portion 102 and the base portion 104 can function as housings for internal components.

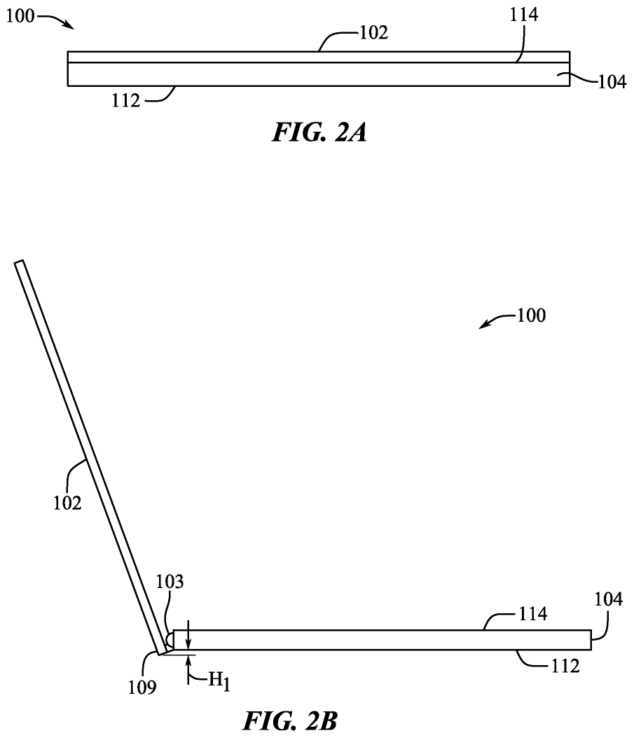

The display 108 can be any form of display, component, or device used to display visual content to a user. For example, the display 108 can be an LED display, an OLED display, an LCD display, or the like. In some examples, the display 108 can be any form of display now known in the art, or as may be developed in the future. In some examples, the display 108 can be a touch screen display, or can have touch detecting capabilities. In some examples, however, the electronic device can be capable of detecting a user's touch, and/or a position of an appendage of the user, by components other than the display 108. Further details of the electronic device 100 are provided below with reference to FIGS. 2A and 2B.

FIG. 2A illustrates a side view of the electronic device 100 in a closed position. When the device 100 is in a closed position, the base portion 104 and the display portion 102 can substantially abut one another at major surfaces thereof, can substantially overlie one another, and/or in some examples, can be substantially parallel to one another. In some examples, the top surface 114 of the base portion 104 can contact (or be adjacent to) the display 108 and/or any major surface of display portion 102 when the electronic device is in a closed position. Further, in a closed position, the edges or sides of the base portion 104 can be substantially aligned (i.e., flush) with the sides of the display portion 102. Thus, in some examples, the device 100 can have a substantially rectangular cuboid shape, although other shapes and profiles are expressly contemplated.

FIG. 2B illustrates the electronic device 100 of FIG. 2A in an open position. The electronic device 100 can be considered to be in an open position when the display portion 102 is rotated or moved away from the base portion 104 such that the display portion 102 is no longer substantially parallel with the base portion 104, and/or a major surface of the display portion 102 is no longer in contact with, or substantially overlying, a major surface of the base portion 104. The display portion 102 can include an edge 109 that is proximate the base portion 104 when the electronic device 100 is in an open position. In some examples, as the display portion 102 is rotated open, the edge 109 of the display portion 102 can rotate below a plane defined by the bottom surface 112 of the base portion 104. For instance, the edge, lip, or other section 109 of the display portion can extend below the bottom surface 112 of the base portion 104 by a distance H₁. The overhanging edge 109 can contact a surface on which the base portion 104 is positioned, such as a table or desk. In some examples, as the display portion 102 reaches an angle of 90 degrees relative to the base portion 104, the edge 109 can begin to extend beyond the bottom surface 112 of the base portion 104. The edge 109 of the display portion 102 can thus contact or scrape against the support surface. In some examples the edge 109 of the display portion 102 can extend at least 3.8 millimeters (mm) below the bottom surface of the base portion. That is, in some examples, H₁ can be at least about 3.8 mm. In some examples, H₁ can be about 10 mm, about 7 mm, 5 mm, about 4 mm, about 3 mm, about 2 mm, about 1 mm, or an even smaller distance below the bottom surface 112 of the base portion 104.

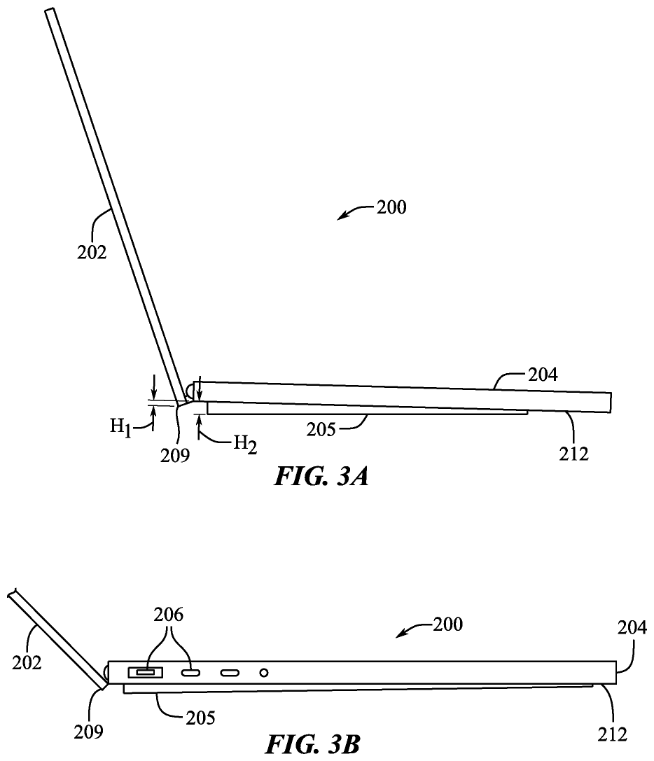

Any variety of configurations can be constructed to include a deployable feature, as described herein. Further, as discussed herein, the process for deploying a deployable feature from a base portion of an electronic device can include any combination of actuation components. Various examples of deployable features, as described herein, and functions of the same, are described below with reference to FIGS. 3A-3B.

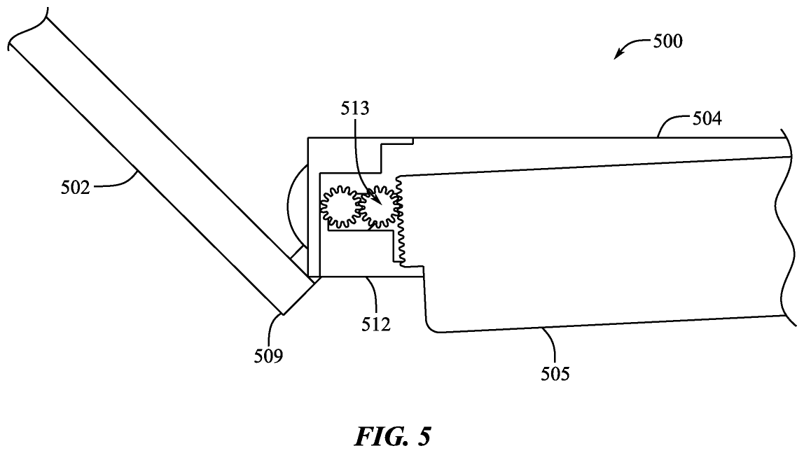

FIG. 3A illustrates an electronic device 200 including a base portion 204 and a display portion 202. The electronic device 200 can be substantially similar to, and can include some or all of the features of the electronic devices described herein, such as electronic device 100. In some examples, the electronic device 200 includes a deployable feature 205. The deployable feature 205 can include, and can be referred to, in whole or in part, as a foot, a stand, or a support. In some examples, however, the deployable features 205 can have alternative or additional functions or structures aside from a foot, a stand or a support. The deployable feature 205 can be disposed or located at a bottom surface 212 of the base portion 204, although in some examples, the deployable feature 205 can be disposed at any other location or locations on the base portion 204. In some examples, the deployable feature 205 can be recessed or housed within an internal volume of the base portion 204, such as when in an un-deployed position or state. In some examples, the deployable feature 205 can be positioned on the sides of the base portion 204. The deployable feature 205 can extend or deploy from the base portion 204. The deployable feature 205 can include an actuation component (described in greater detail below, for example, with reference to FIGS. 5-15). The actuation component can extend or deploy at least a portion of the deployable feature 205 from the base portion 204. It will be understood that the deployable feature 205 can extend from any portion of the base portion (e.g., bottom surface 212, top surface, and/or side walls). The deployable feature 205 can raise, lift, or provide support for the electronic device 200 such that the deployable feature 205 provides clearance for an edge 209 of the display portion 202 as it opens or as it sits in an open position. For instance, the deployable feature 205 can extend a distance of H₂ from the bottom surface 212 of the base portion 204, where H₂ is greater than H₁ (the distance that the edge 209 of the display portion 202 extends below the bottom surface 212 of the base portion 204). The deployable feature 205 can be made from a variety of materials. In some examples, at least some of the deployable feature can include materials such as metal, plastic, and/or rubber.

The deployable feature 205 can deploy from the base portion 204 in response to a wide variety of events, triggers, signals, and/or states. In some examples, the deployable feature 205 can deploy when the electronic device 200 is in, or is moved into, an open position. In some examples, deployment of the deployable feature 205 depends on the angle between the display portion 202 and the base portion 204, for example, when the angle is an obtuse angle. In some examples, any separation between the display portion 202 and the base portion 204 can cause the deployable feature or features 205 to deploy. For instance, the base portion 204 can include a proximity sensor to detect when the display portion 202 comes into proximity or separates from the base portion 204, and in response, can deploy or retract the deployable feature 205. In some examples, the deployable feature 205 can deploy automatically when an angle between the base portion 204 and the display portion 202 is 90 degrees or greater. In some examples, the deployable feature 205 can deploy in response to the display portion 202 being rotated or moved toward an open position, that is, in the direction of an open position. In some examples, the deployable feature 205 can deploy in response to movement of the display portion 202 relative to the base portion 204 in a manner not associated with the transition of the device 200 between open and closed positions. For example, the display portion 202 can rotate relative to the base portion 204 so that it is moved into an open position, and the display portion 202 can be moved laterally, such as by sliding, relative to the base portion 204 to deploy the deployable feature 205, regardless of whether the device 200 is in an open or closed position.

In some examples, an actuation member can translate rotational motion of the display portion 202 into motion to deploy the deployable feature 205. Although, in some examples, the motion of the display portion 202 may not be physically coupled to the motion of the deployable feature 205. In some examples, the deployable feature 205 deploys when an operating condition of the electronic device 200 occurs. In some examples, the deployable feature 205 deploys in response to a detection of a temperature or a processing speed of the electronic device 200, for example, a detection above a desired threshold. In some examples, the deployable feature 205 deploys in response to a user input on an input member (e.g., on/off switch or keypress). In some examples, there can be a dedicated input member for deploying the deployable feature 205. In some examples, the deployable feature 205 can be deployed manually in response to a physical force from a user applied to the deployable feature 205, such as pushing, pulling, sliding, rotating, and other forces.

Likewise, once in a deployed positioned, the deployable feature 205 can be configured to retract back toward the base portion 204 in response to a wide variety of events, states, signals, and/or conditions. In some examples, the deployable feature 205 can retract when the electronic device 200 is in a closed position. In some examples, the deployable feature 205 can retract depending on the angle between the display portion 202 and the base portion 204, for example, when the angle is an acute angle or is less than 90 degrees. In some examples, the deployable feature 205 can retract when the display portion 202 is being rotated or moved toward a closed position. In some examples, an actuation member can translate rotational motion of the display portion 202 into motion of the deployable feature 205 to retract the deployable feature 205. Although, in some examples, the motion of the display portion 202 may not be physically coupled to the motion of the deployable feature 205. In some examples, the deployable feature 205 retracts when an operating condition of the electronic device 200 occurs. In some examples, the deployable feature 205 retracts in response to a temperature or a processing speed of the electronic device 200 being detected, such as when a temperature, a processing speed, or any other condition is detected below a desired threshold. In some examples, the deployable feature 205 retracts in response to a user input on an input member (e.g., on/off switch or keypress). In some examples, the deployable feature 205 can retract in response to physical force from a user being applied to the deployable feature 205, such as pushing, pulling, sliding, rotating, and other forces. It will be understood that the deployable feature 205 can deploy even if the electronic device 200 is in a closed position (i.e., the edge 209 is not below the bottom surface 212). Further details of deployment mechanisms and methods/conditions for retracting deployable features are provided below.

FIG. 3B illustrates the electronic device 200 including various input/output ports 206, such as USB, headphone, charging, HDMI and other ports. In some examples, the deployable feature 205 can be configured to cooperate with the input/output ports 206 to ensure that the functionality of the electronic device 200 is not inhibited or interfered with as a result of the deployable feature 205. That is, in some examples, the deployable feature 205 can be positioned at a location or locations on the base portion 204 adjacent to one or more ports, and can deploy from the base portion 204 without inhibiting access, such as by a user, to the one or more ports.

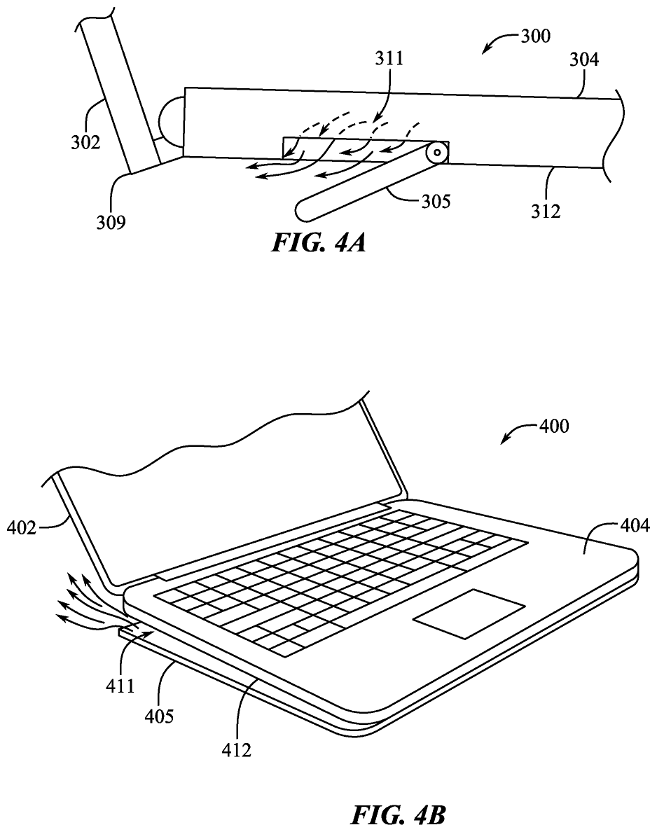

Any variety of configurations can be constructed to include a deployable feature, as described herein. Further, as discussed herein, the process for deploying a deployable feature from a base portion or an electronic device can include any combination of actuation components. Various examples of deployable features, as described herein, and functions of the same, are described below with reference to FIGS. 4A-19.

FIG. 4A illustrates an electronic device 300. The electronic device 300 can be substantially similar to, and can include some or all of the features of the electronic devices described herein. The electronic device 300 can include a deployable feature 305 that extends from a bottom surface 312 of the base portion 304. In addition, or alternative, to providing clearance for an edge 309 of the display portion 302, in some examples, the deployable feature 305 and the base portion 304 can define a vent 311 that can be in fluid communication with an internal volume define by the housing of the device 300, such as by the base portion 304. In some examples, an air-moving component or components, such as an intake fan and/or an exhaust fan, can be at least partially disposed in this internal volume and can be in fluid communication with the vent 311. The intake and/or exhaust fan can force air to move from the ambient environment into the internal volume. In some examples, air can be moved into internal volume through the vent 311 and over internal components of the electronic device 300 to provide cooler air to transfer thermal energy from the object and significantly increase the rate of cooling. The vent 311 can serve as an exhaust vent and/or an intake vent for the electronic device 300. In some examples, the base portion 304 of the electronic device 300 can additionally, or alternatively include or define apertures, perforations, vents, or other features that can allow for air to be moved in and/or out of the internal volume at locations on the bottom surface 312 adjacent or near to the deployable feature 305 and/or the vent 311.

In some examples, the vent 311 can help to separate the intake and exhaust locations for the internal volume of the device 300, so as to prevent or reduce recirculation and to improve the cooling efficiency of the device 300. For example, an air intake vent can be disposed at a desired location that is separate from the vent 311, while the vent 311 can act as an exhaust for the internal volume of the device 300. The location of the intake can be chosen so that air exhausted from the vent 311 is directed away from the intake location, thereby reducing the amount of heated exhaust air that is taken into the internal volume again. Further, in some examples, the vent 311 can act as both an intake and exhaust vent for the internal volume, but can include a dividing member that can divide the vent 311 and separate the portion of the vent 311 used to intake air from the portion used to exhaust air. In some examples, the dividing member can be moveable, for example, to change the area of the intake and exhaust portions of the vent 311 relative to one another. In some examples, the moveable dividing member can be actuated by the actuation component, or it can be moved when the deployable feature 305 is deployed. In some examples, the dividing member can be moved independent of the deployable feature, for example, in response to a state of the device, such as a thermal load.

In some examples, the operation of a fan or other cooling system can depend on the position or state of the deployable feature 305, or vice versa. For instance, a fan can operate at full power when the deployable feature 305 is in a deployed state, allowing for maximum ventilation. In some examples, the position of the deployable feature 305 can depend on the speed of the fan, or vice versa. For instance, as the fan speed increases, indicating an increased need for cooling, the deployable feature 305 can extend to allow increased airflow to enter the vent 311 and the internal volume. In some examples, the deployable feature 305 can extend in response to a temperature of the electronic device 300. For instance, a threshold temperature, above which it may not be desirable to continuously operate the electronic device 300, can be determined. Thus, if the temperature of the electronic device 300 is approaching or has exceeded the predetermined threshold temperature, a determined by system sensors, the deployable feature 305 can be deployed to lower the operating temperature of the electronic device 300.

FIG. 4B shows an electronic device 400 in an open position (i.e., a display portion 402 being separated from a base portion 404). The electronic device 400 can be substantially similar to, and can include some or all of the features of any of the electronic devices described herein, such as electronic device 300. The electronic device 400 can include a deployable feature 405 that is disposed below the base portion 404. In some examples, the deployable feature 405 can cover or overlie substantially all of the bottom surface 412 of the base portion 404. In response to deploying the deployable feature 405, a gap or a separation can be created between the deployable feature 405 and the bottom surface 412. This separation can operate as a vent 411 for the electronic device 400, such as for an internal volume defined by the base portion 404. For example, a user might place the electronic device 400 on a surface that does not allow proper ventilation, such as a lap, a bed, a cushion, or another poor ventilating surface or poor heat conductor. When placed on such a material or surface, the electronic device 400 may not achieve desired levels of cooling. Accordingly, the deployable feature 405 can raise the base portion 404 away from the surface to allow desired levels of ventilation and/or cooling of the electronic device 400. Further details of actuation components for deploying deployable features are provided below with reference to FIGS. 5-15.

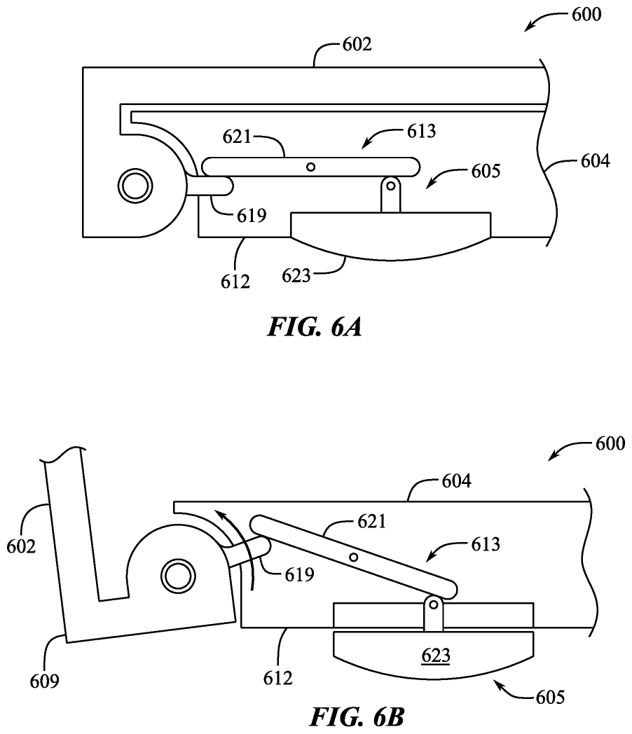

FIG. 5 shows an electronic device 500 including a deployable feature 505. The electronic device 500 can be substantially similar to, and can include some or all of the features of any of the electronic devices described herein, such as electronic devices 200, 300. The deployable feature 505 can move up and/or down, and can be driven by an actuation component 513. The actuation component 513 can deploy and/or retract the deployable feature 505. In some examples, the actuation component 513 can be or can include a gear train, that is, a series of gears that mechanically couple the display portion 502 to the deployable feature 505. Thus, in some examples, as the display portion 502 rotates open or closed, the gear train 513 causes the deployable feature 505 to deploy or retract, respectively. In this manner, the deployable feature 505 can provide clearance for the edge 509 of the display portion 502 as it extends below the bottom surface 512 of the base portion 504. Any number or variety of gears and gear ratios can be used to couple the motion of the display portion 502 with the deployable feature 505. Further details of various actuation components of deployable features are provided below with reference to FIGS. 6A and 6B.

FIGS. 6A and 6B illustrate a deployable feature 605 of an electronic device 600. The electronic device 600 can be substantially similar to, and can include some or all of the features of any of the electronic devices described herein, such as electronic device 500. The deployable feature 605 can be positioned at least partially within the base portion 604, such as within an internal volume defined by the base portion 604. For instance, a bottom surface 612 of the base portion can define a recess or opening in which the deployable feature 605 is housed. In some examples, the deployable feature 605 is positioned on an exterior side of the base portion 604. The deployable feature 605 can include an actuation component 613 to deploy the deployable feature 605. The actuation component 613 can include a protrusion 619 extending from the display portion 602 and/or hinge assembly. As shown in FIG. 6B, as the display portion 602 rotates open relative to the base portion 604, the protrusion 619 also rotates, forcing rotation of a lever 621. As the lever 621 rotates, it forces a support or a foot 623 of the deployable feature 605 downward, consequently providing clearance for edge 609. In some examples, the weight of the electronic device 600 can cause the foot 623 to retract into the base portion 604 once the display portion 602 is closed. In some examples, the deployable feature 605 is biased toward the base portion 604.

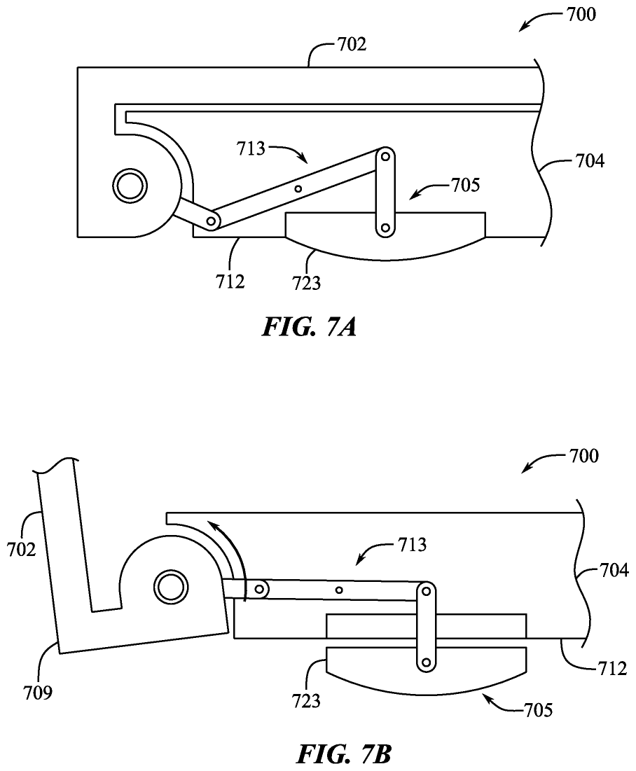

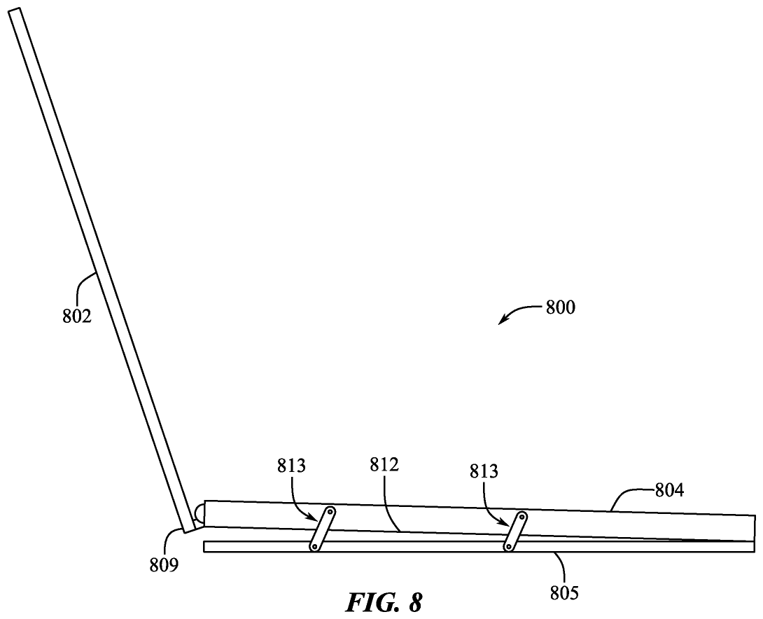

FIGS. 7A and 7B show a deployable feature 705 of an electronic device 700. The electronic device 700 can be substantially similar to, and can include some or all of the features of any of the electronic devices described herein, such as electronic devices 500, 600. In some examples, an actuation component 713 can include a lever that is moveably attached to a display portion 702 and a foot 723 of the deployable feature 705, for example, by pivot points. As the display portion 702 is open or closed, the actuation component 713 forces the foot 723 to deploy or retract, respectively. As shown in FIG. 7B, the foot 723 can extend from a bottom surface 712 of the base portion 704 to a distance that is lower than the edge 709. The deployable feature 705 and actuation component 713 can be disposed within the base portion 704, or can be position on a sidewall thereof. Further details of various actuation components of deployable features are provided below with reference to FIG. 8.

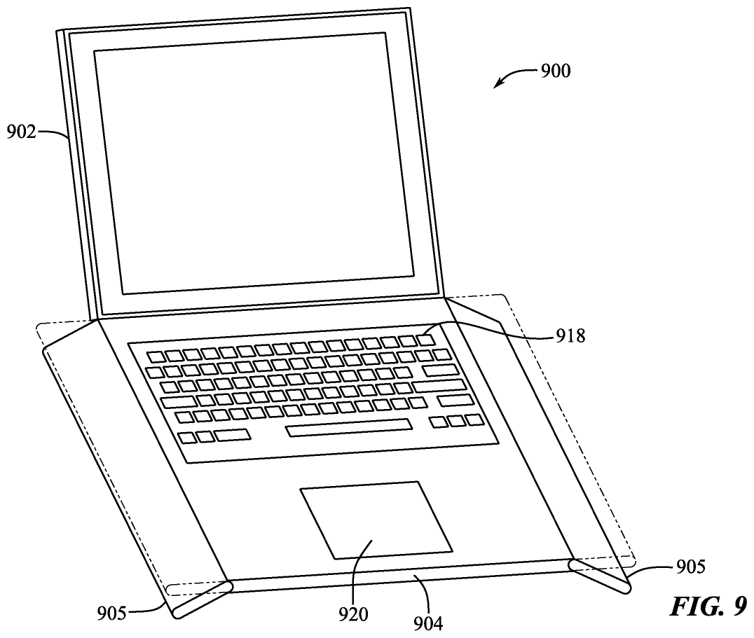

FIG. 8 shows an electronic device 800 including a deployable feature 805. The electronic device 800 can be substantially similar to, and can include some or all of the features of any of the electronic devices described herein. In some examples, the deployable feature 805 is moveably attached to the base portion 804 by a four-bar type linkage system 813. For instance, the deployable feature 805 can be attached to the base portion 804 on opposing sides by one or more pivotable arms 813. In some examples, the four-bar system 813 can be bi-stable (e.g., the deployable feature 805 is in a stable state when either fully deployed or un-deployed). In some examples, a user of the electronic device 800 can deploy the deployable feature manually, can provide an input to deploy the deployable feature 805, or the deployable feature 805 can be deployed automatically, for example, upon detection of a desired condition or state by the device 800. Once deployed, the bottom surface 812 of the base portion 804 and the deployable feature 805 can be at least partially separated to sufficiently raise the display portion 802 to facilitate rotation of the edge 809. Further details of various deployable features are provided below with reference to FIG. 9.

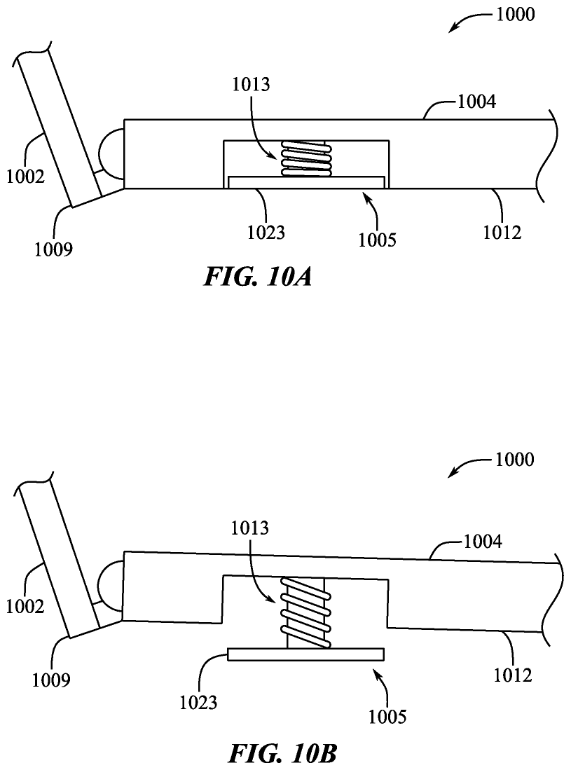

FIG. 9 illustrates an electronic device 900 including deployable features 905. The electronic device 900 can be substantially similar to, and can include some or all of the features of any of the electronic devices described herein. The deployable features 905 can include partially foldable wings or sides. The wings 905 can be rotatably or moveably coupled to sides of the base portion 904. In some examples, the deployable features 905 can be part of, or can define the sides of the base portion 904. In an un-deployed state, the wings 905 can lie in the same plane as the base portion 904. In a deployed state, the wings 905 can move out of the plane of base portion 904, for example, pivoting or moving downward to serve as legs, stands, or supports of the electronic device 900. The wings 905 can be rotated by a user or via automation. In some examples, the wings 905 run along substantially the entire length of the sides of the base portion 904. In some examples, the wings 905 run along less than an entirety of a side of the base portion. In some examples, it can be advantageous to provide recesses in the wings 905 such that as the display portion 902 is rotated open, the edge of the display portion does not come into contact with the folded down wings 905. Further details of various actuation components and various deployable features are provided below with reference to FIGS. 10A and 10B.

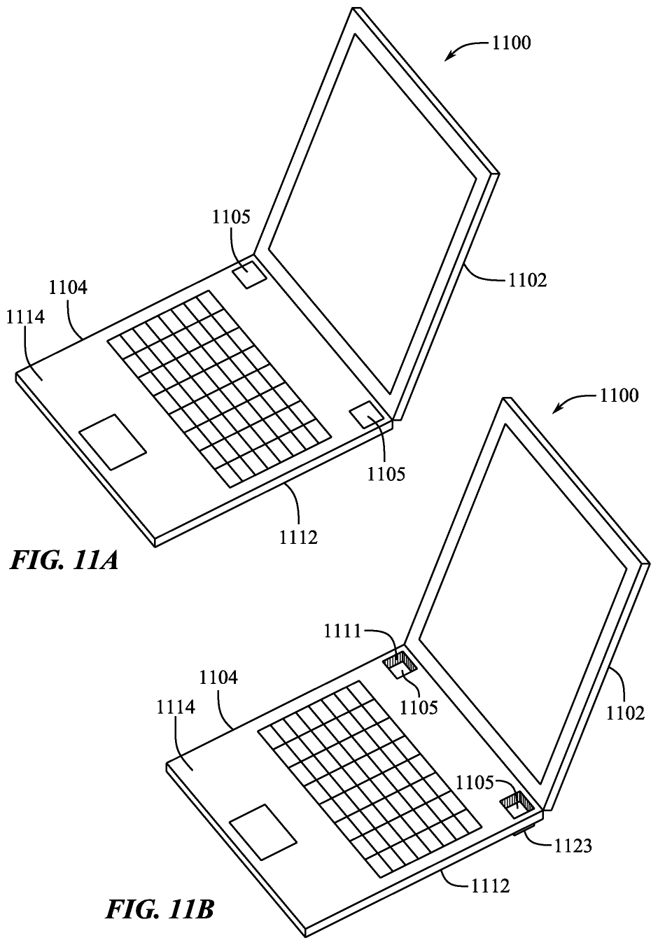

FIGS. 10A and 10B show an electronic device 1000. The electronic device 1000 can be substantially similar to, and can include some or all of the features of any of the electronic devices described herein. FIGS. 10A and 10B illustrate a bi-stable deployable feature 1005 that includes an actuation component 1013, similar to a push-push or push-turn button like system, to deploy and retract the deployable feature 1005. In some examples, the deployable feature 1005 can include a spring that biases a foot or lower structure 1023 of the deployable feature 1005 downward (i.e., toward a deployed state). In some examples, a user can push down on the base portion 1004 or directly on the deployable feature 1005 to release or deploy the deployable feature 1005. The foot 1023 can extend lower than an edge 1009 of the display portion 1002 when in an open position. The user can again push down and release the base portion 1004 or deployable feature 1005 to retract the deployable feature 1005 into the base portion 1004. When in an un-deployed state, the foot 1023 can extend slightly from the bottom surface 1012 of the base portion 1004 to enable sufficient travel when a user pushes on the base portion 1004 to engage the push-turn mechanism. Further details of example actuation components and designs of deployable features are provided below with reference to FIGS. 11A and 11B.

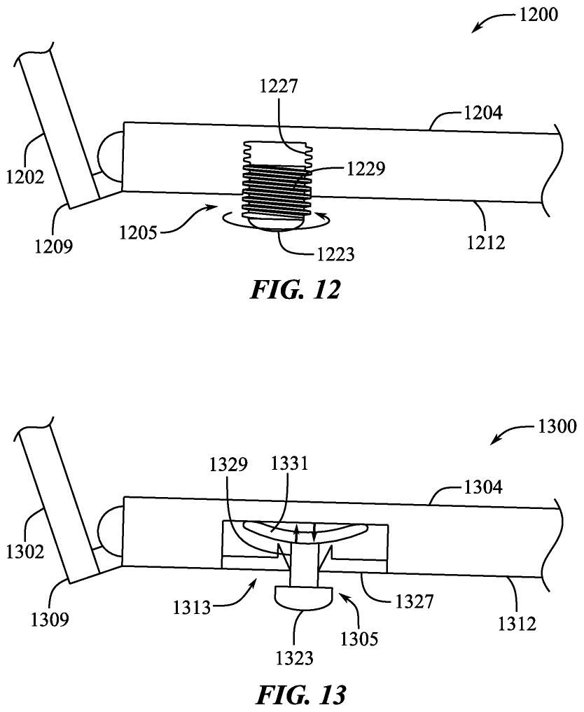

FIGS. 11A and 11B illustrate an electronic device 1100. The electronic device 1100 can be substantially similar to, and can include some or all of the features of any of the electronic devices described herein. As shown in FIG. 11A, in an un-deployed state, the deployable features 1105 can be substantially flush with a top surface 1114 of the base portion 1104. A user can then apply pressure to the top of the deployable features 1105 such that feet or lower portions 1123 of the deployable features 1105 extend through the bottom 1112 of the base portion 1104 and raise the electronic device 1100, as shown in FIG. 11B. In some examples, a user can push the deployable feature through an upper surface 1114 of the base portion 1104. In some examples, the deployable features 1105 can be moved or driven by an actuation component and may not require a user input or the exertion of force by a user to deploy. The sidewalls of the base portion 1104 that define an aperture in which the deployable feature 1105 can be disposed can include vents 1111 to increase airflow and cooling of the electronic device. The vents 1111 can be in fluid communication with an internal volume defined by the base portion 1104, for example, an internal volume containing one or more computing components. By allowing the user to deploy the deployable feature 1105 from the top 1114 of the base portion 1104, the user can access and deploy the feet 1123 of the electronic device 1100 without raising or upturning the electronic device 1100. Further, such a configuration allows a user to easily determine whether the feet 1123 are deployed without upturning or raising the electronic device 1100. In some examples, the feet 1123 can be forced back into the base portion 1104 by applying upward pressure on the feet 1123. In some examples, the feet 1123 can be automatically retracted into the base portion 1104. This can be done even when the electronic device 1100 is closed and the display portion 1102 covers the top surface 1114. Further details of deployable features are provided below with reference to FIG. 12.

FIG. 12 illustrates an electronic device 1200. The electronic device 1200 can be substantially similar to, and can include some or all of the features of any of the electronic devices described herein. In some examples, the electronic device 1200 includes a deployable feature 1205 including threads 1229. The base portion 1204 can define a recess including corresponding threads 1227 formed on the sidewalls of the recess. In some examples, the base portion 1204 can include one or more other components that can define the corresponding threads 1227. The threads 1229 of the deployable feature 1205 can engage with the threads 1227 of the base portion 1204 to screw the deployable feature 1205 in and out of the recess. Rotating the deployable feature 1205 can cause a foot 1223 of the deployable feature 1205 to extend or retract from a bottom surface 1212 of the base potion 1204, allowing for customizable height of the deployable feature 1205 and the base portion 1204 from a support surface, such as a table. For instance, the deployable feature 1205 can be rotated to the extent that is provides sufficient clearance for an edge 1209 of the display portion 1202. In some examples, the deployable feature 1205 can be rotated manually by a user. In some examples, the deployable feature 1205 is rotated automatically by an actuation component, such as any of the actuation components discussed herein. Additional details of various actuation components and deployable features are provided below with reference to FIG. 13.

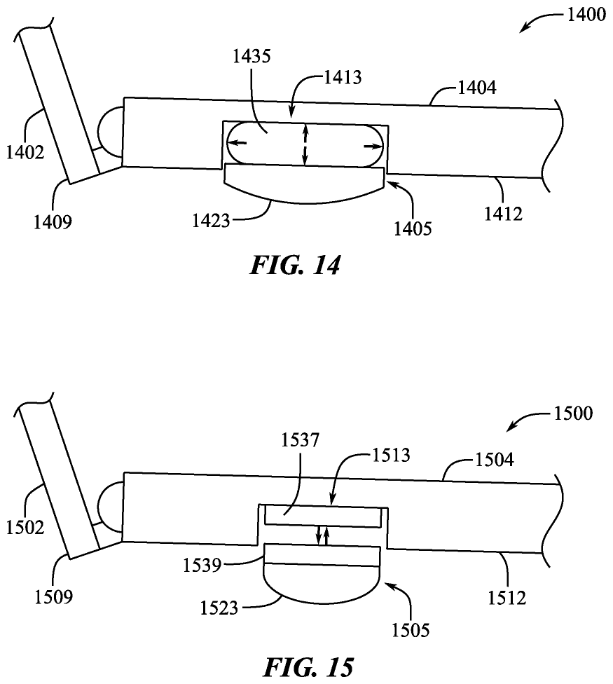

FIG. 13 shows an electronic device 1300 including a deployable feature 1305. The electronic device 1300 can be substantially similar to, and can include some or all of the features of any of the electronic devices described herein. In some examples, the electronic device 1300 includes an actuation component 1313. The actuation component 1313 can include a piezo actuator 1331. The piezo actuator 1331 can be a ceramic or any other material that expands, contracts, or otherwise changes shape when an electrical charge is applied thereto, generating motion and/or force. In some examples, the piezo actuator 1331 is connected through a shaft 1329 to a foot 1323 that can extend from a bottom surface 1312 of the base portion 1304. When an electrical charge is applied, the piezo actuator 1331 changes shape to deploy the foot 1323 with enough clearance for an edge 1309 of a display portion 1302, as described herein. The deployable feature 1305 can further include retaining features 1327 configured to retain the shaft 1329 in a certain position (e.g., through friction). The retaining features 1327 can be configured to allow for unidirectional motion. Thus, in some examples, repeated motion from the piezo actuator 1331 can drive the deployment of the deployable feature 1305. For example, the piezo actuator 1331 may only move or expand a relatively small distance in response to the application of a current, but a current can be repeatedly applied to the piezo actuator 1331 to cause repeated expansion, such as at a high frequency, to drive deployment of the foot 1322 in a ratchet type process. The retaining features 1327 can be actuated to release the foot 1323 to allow the foot 1323 to retract into the base portion 1304, for example, in response to a signal or input from a user. Additional details of various actuation components and deployable features are provided below with reference to FIG. 14.

FIG. 14 shows an electronic device 1400 including a deployable feature 1405. The electronic device 1400 can be substantially similar to, and can include some or all of the features of any of the electronic devices described herein. In some examples, the deployable feature 1405 can include a pneumatic actuator 1413. The pneumatic actuator 1413 can utilize pressurized gas or liquid to inflate a bladder 1435. The expansion or inflation of the bladder 1435 can then deploy a foot 1423 from a bottom surface 1412 of a base portion 1404, as described herein. In some examples, the bladder 1435 can be inflated to the point that the foot 1423 extends lower than an edge 1409 of a display portion 1402. In some examples, the device 1400 can include one or more components that can inflate or cause expansion of the bladder 1435. For example, the device 1400 can include a pump, a tank, or another air moving device. In some examples, an electrically drive system can pressurize a tank that is in fluid communication with the bladder 1435. Pressure can be provided from the tank to the bladder 1435, as desired, to deploy the feature 1405, for example, in response to a signal. In some examples, any other components or methods for inflating the bladder 1435 can be used. Additional details of various actuation components and deployable features are provided below with reference to FIG. 15.

FIG. 15 illustrates an electronic device 1500 including a deployable feature 1505. The electronic device 1500 can be substantially similar to, and can include some or all of the features of any of the electronic devices described herein. In some examples, the deployable feature 1505 can include a magnetic actuation component 1513. In some examples, the actuation component 1513 can include one or more magnets that can be actively switched to provide a force that can deploy the deployable feature 1505. A first magnet 1537 can be disposed within a recess of the base portion 1504. A second magnet 1539 can be disposed adjacent to the first magnet 1537 (e.g., positioned directly beneath the first magnet 1537). The second magnet 1539 can be attached to a foot 1523 that extends from a bottom surface 1512 of the base portion 1504. The first magnet 1537 and/or the second magnet 1539 can have adjustable or switchable polarizations, such that the first magnet 1537 and the second magnet 1539 can repel each other in a first state, and can attract each other in a second state. In some examples, the first magnet 1537 and/or the second magnet 1539 can include ALNICO magnets. The magnets can include aluminum, nickel, and Cobalt, among other materials.

When the deployable feature 1505 is in an un-deployed state, the first magnet 1537 and the second magnet 1539 can be in contact with one another. When the deployable feature 1505 is in a deployed state, the repulsive forces generated by the first magnet 1537 and the second magnet 1539 can cause the first magnet 1537 and the second magnet 1539 to be separated by a gap. For instance, when the deployable feature 1505 is in an un-deployed state, the first magnet 1537 and the second magnet 1539 can be in a state of attraction. A user can then deploy the deployable feature 1505 by providing an input, or a signal can automatically be provided to deploy the deployable feature 1505. In response, the first magnet 1537 can then change its polarization to repel the second magnet 1539, thereby causing a separation between the first magnet 1537 and the second magnet 1539, thereby extending the foot 1523 of the deployable feature 1505 below the bottom surface of the base portion 1504.

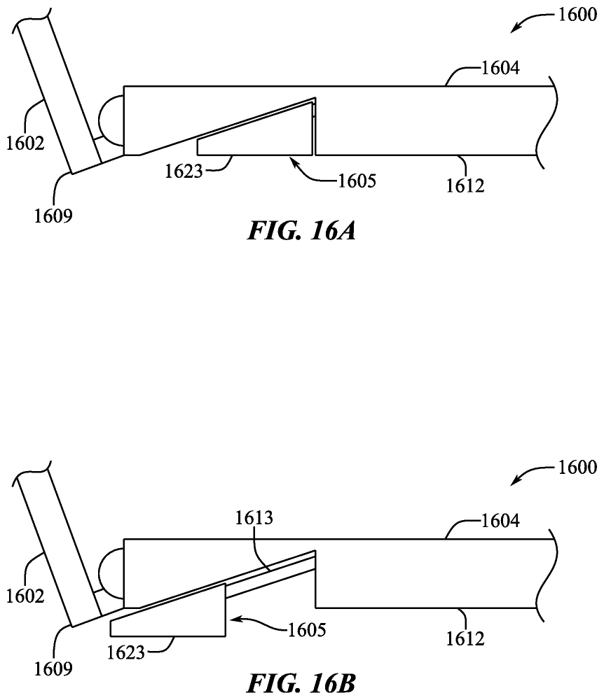

In some examples, the magnets 1537 and 1539 may not attract one another, and the deployable feature 1505 can instead rely on a physical force, such as the weight of the base portion 1504, to retract. The second magnet 1539 and/or the foot 1523 can be movably attached to the base portion 1504 such that as the first magnet 1537 repels the second magnet 1539, it does not become separated from the base portion 1504. The deployable feature 1504 can include tracks or rails on which the foot 1523 and/or second magnet 1539 travel. The tracks can prevent the second magnet 1539 and the foot 1523 from becoming completely separated from the base portion 1504. The tracks can allow the foot 1523 to extend below the level of an edge 1509 of the display portion 1502 to a desired distance. Further details of various functionalities of deployable features are provided below with reference to FIGS. 16A-21.

FIG. 16 illustrates an electronic device 1600 including a deployable feature 1605. The electronic device 1600 can be substantially similar to, and can include some or all of the features of any of the electronic devices described herein. In some examples, the deployable feature 1605 can include a ramped structure or shape, for example, a ramped support structure 1623 that can be disposed at the bottom surface 1612 of the base portion 1604 of the device 1600. In some examples, in an un-deployed state, the foot or support structure 1623 can be substantially flush or level with the bottom surface 1612 and can, for example, be at least partially disposed in the base portion 1604, such as in a recess, cavity, or internal volume defined by the base portion 1604.

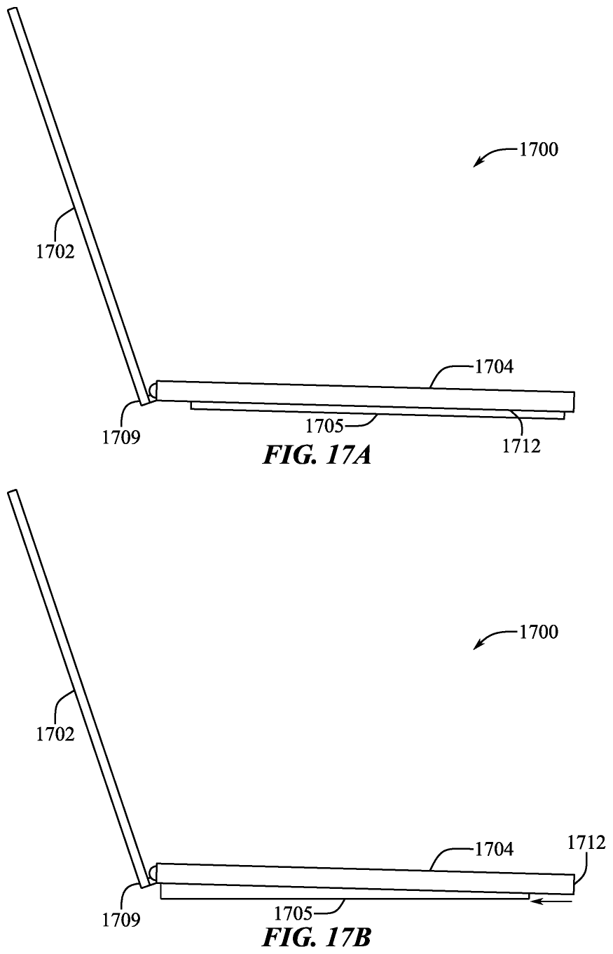

FIG. 16B shows the deployable feature 1605 in a deployed position. As can be seen, the foot 1623 can slide or otherwise be deployed by an actuation component 1613 that can include, for example, a rail or rails. In its deployed state, the foot 1623 can be disposed lower than the lowermost edge or portion 1609 of the display portion 1602. In some examples, the deployable feature 1605 can be deployed by any of the mechanisms described herein, and in response to any of the conditions described herein. For example, the deployable feature 1605 can deploy when the display portion 1602 is moved relative to the base portion 1604. In some examples, the deployable feature 1605 can be user actuated, and can be manually deployed by a user, as desired. Additional details of various actuation components and deployable features are provided below with reference to FIGS. 17A and 17B.

FIG. 17A illustrates an electronic device 1700 including a deployable feature 1705. The electronic device 1700 can be substantially similar to, and can include some or all of the features of any of the electronic devices described herein. As can be seen, in some examples, the deployable feature 1705 can be disposed at the bottom surface 1712 of the base portion 1704 of the device 1700. In some examples, the deployable feature 1705 can extend past or further than a lower portion 1709 of a display portion 1702, even when in an un-deployed state. In some examples, however, the deployable feature 1705 may not extend past or further than a lower portion 1709 of a display portion 1702 in an un-deployed state. In some examples, the deployable feature 1705 can occupy or define substantially all, or a majority, of the lower surface 1712 of the base portion 1704, although the deployable feature 1705 can have any of the shapes and configurations described herein.

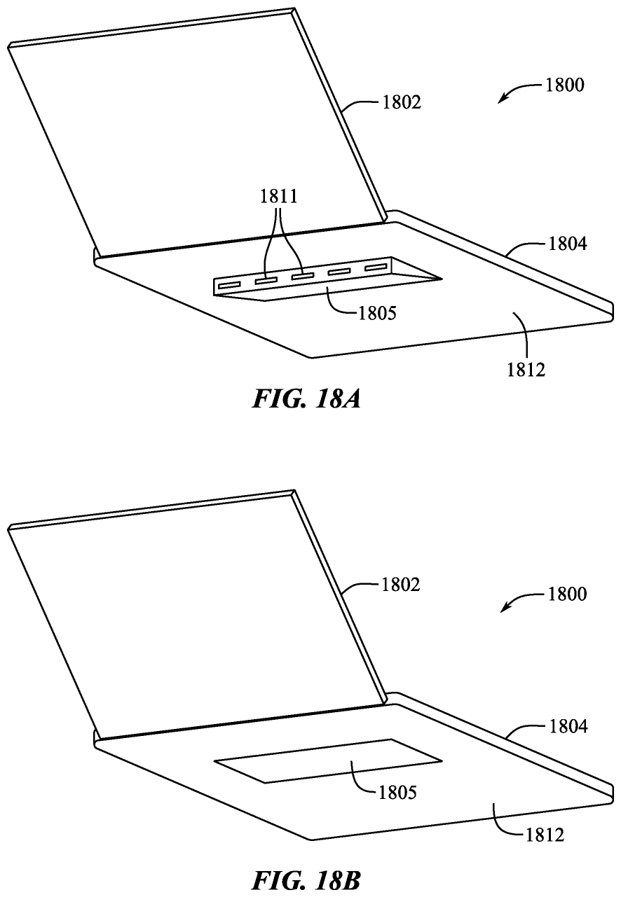

FIG. 17B shows the deployable feature 1705 in a deployed position. As can be seen, the deployable feature 1705 has moved laterally relative to the base portion 1704. In some examples the deployable feature 1705 can also move vertically relative to the base portion 1704, in addition to moving laterally. That is, the distance H₂ can increase as the deployable feature 1705 moves laterally relative to the base portion 1704. In some examples, the movement of the deployable feature 1705 can be automatically driven, such as by an actuation component including a motor, or other device that can deploy the feature 1705 automatically. In some examples, the feature 1705 can be deployed in response to any number of conditions, events, or states, as described herein. In some examples, however, the deployable feature 1705 can be deployable by a user. For example, a user can manually exert a force or pressure on the feature 1705 to move the feature between an un-deployed and a deployed state, as described herein. Additional details of various actuation components and deployable features are provided below with reference to FIGS. 18A and 18B.

FIGS. 18A and 18B illustrate rear perspective views of an electronic device 1800 including a deployable feature 1805. The electronic device 1800 can be substantially similar to, and can include some or all of the features of any of the electronic devices described herein. FIG. 18A shows the deployable feature 1805 extending from a bottom surface 1812 of the base portion 1804. In some examples, the deployable feature 1805 can define vents 1811 that are formed directly in the deployable feature 1805. By having the deployable feature 1805 shaped and positioned along a rear edge (i.e., the edge of the base portion proximate the display portion 1802), the electronic device 1800 can comfortably and securely rested on the lap of a user. FIG. 18B shows the deployable feature 1805 retracted into the base portion 1804. In some examples, when the deployable feature 1805 is retracted into the base portion 1804, the deployable feature is substantially flush with the bottom surface 1812 of the base portion 1804 and can leave little or no gaps. The tight-fitting deployable feature 1805 can prevent ingress of dust and debris when in an un-deployed state.

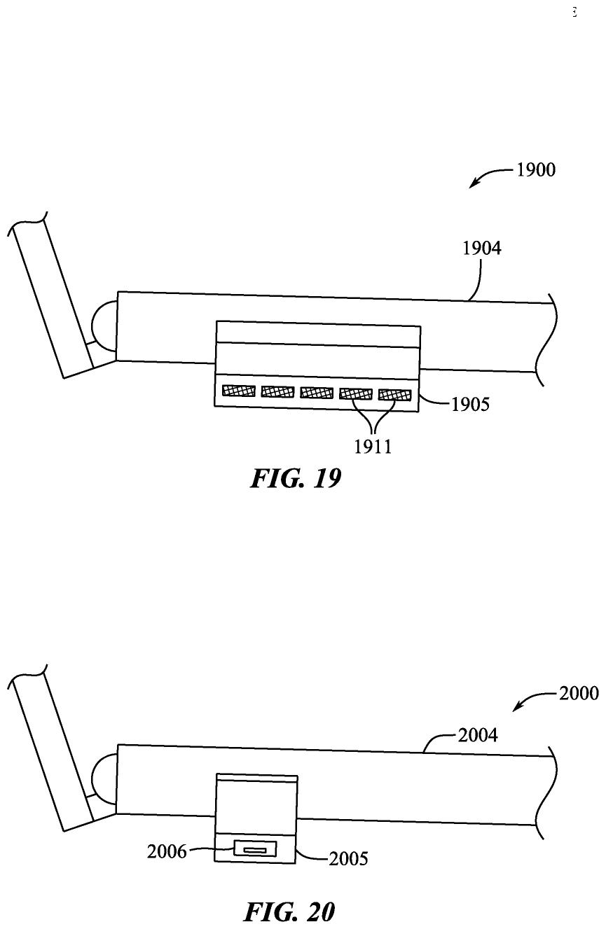

FIG. 19 shows an electronic device 1900. The electronic device 1900 can be substantially similar to, and can include some or all of the features of any of the electronic devices described herein, such as electronic devices 300, 400, 1800. In some examples, the deployable feature 1905 can define a portion of the side of the base portion 1904 (i.e., a face or surface of the deployable feature 1905 can be flush with a side of the base portion 1904). This can allow vents 1911 defined by the deployable feature 1905 to remain uncovered and capable of providing fluid communication between the ambient environment and an internal volume defined by the base portion, even in an un-deployed state. In some examples, the vents 1911 can draw and/or expel air, regardless of whether the deployable feature 1905 is deployed or not. Further details of various deployable features are discussed with respect to FIG. 20 below.

FIG. 20 illustrates an electronic device 2000 including a deployable feature 2005. The electronic device 2000 can be substantially similar to, and can include some or all of the features of any of the electronic devices described herein. The deployable feature 2005 can define or include an input/output port 2006, such as a USB port, audio/video port, charging port, or any other input/output ports. The port 2006 can operate when the deployable feature 2005 is both in a deployed state and in a recessed or un-deployed state. For instance, the deployable feature 2005 can define a portion of the side of the base portion 2004 (i.e., a face of the deployable feature 2005 is flush with a side of the base portion 2004). This can allow the input/output port 2006 defined by the deployable feature 2005 to be accessible, regardless of whether the deployable feature 2005 is deployed or not.

In some examples, the deployable feature 2005 including the port 2006 does not define a portion of the side of the electronic device 2000. In such examples, the deployable feature 2005 can provide an additional space for a port (or other component) that may not otherwise be able to fit on the side of the base portion 2004. In some examples, use of the port 2006 can trigger or signal to the deployable feature 2005 to deploy. For instance, the deployable feature 2005 can define a charging port capable of charging the electronic device 2000. In response to plugging in a charging cable, the deployable feature 2005 can automatically deploy in order to provide desired levels of ventilation and cooling for the electronic device 2000 while charging. It will also be understood that the deployable feature 2005 can serve multiple functions. For instance, the deployable feature 2005 can define both an input/output port 2006 as well as a vent for air intake or exhaust, or any other functionalities described herein. In some examples, the deployable feature 2005 can be sized, shaped, and/or positioned to not interfere with input/output ports. In some examples, an input/output port can be positioned behind the deployable feature 2005 such that as the deployable feature 2005 deploys, an input/output port 2006 is revealed and can be accessed.

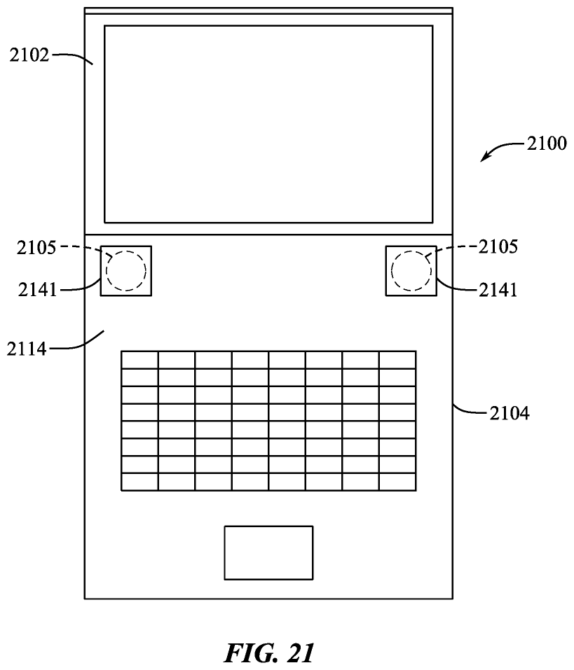

FIG. 21 illustrates a top view of an electronic device 2100 including deployable features 2105 disposed directly beneath internal components 2141. The electronic device 2100 can be substantially similar to, and can include some or all of the features of any of the electronic devices described herein. The internal components 2141 can be located within the base portion 2104, and can be exposed through a top surface 2114 thereof. In some examples, the internal components 2141 can be speakers, antennae, or other components that typically utilize an air volume or space to operate properly. In some examples, when the deployable features 2105 are deployed, the space in the internal volume defined by the base portion 2104 in which the deployable feature 2105 was housed in an un-deployed state can provide an air volume or space that can be utilized by one or more of the internal components 2141.

For example, the internal components 2141 can be loudspeakers that can include a diaphragm or other air-moving component. In some examples, when the deployable features 2105 are deployed, components of the loudspeakers 2141, such as the diaphragms, can expand at least partially into the space formerly occupied by the deployable features 2105, and/or into a space or volume that can at least partially be defined by the deployed deployable feature 2105. In some examples, space that was occupied and/or is at least partially defined by the deployable features 2105 can be utilized as a resonant space for one or more loudspeakers 2141, such as to allow for higher volume and/or quality acoustic outputs therefrom. Similarly, in some examples where the internal components 2141 can be antennae, such as cellular, Bluetooth, Wi-Fi, or any other types of antennae, the volume at least partially defined by the deployed deployable feature 2105 can allow for higher quality transmission and/or reception of signals by the antennae 2141.

While FIG. 21 shows the deployable features 2105 being positioned directly beneath the internal components 2141, it will be understood that the deployable features could be positioned on the sides or on top of the internal components 2141, or at any other position, and can still provide the benefits and functionalities discussed herein. In some examples, the internal components 2141 can be configured to expand their size to occupy at least some of the space which was previously occupied by the deployable feature 2105, or that is at least partially defined by the deployable features 2105.

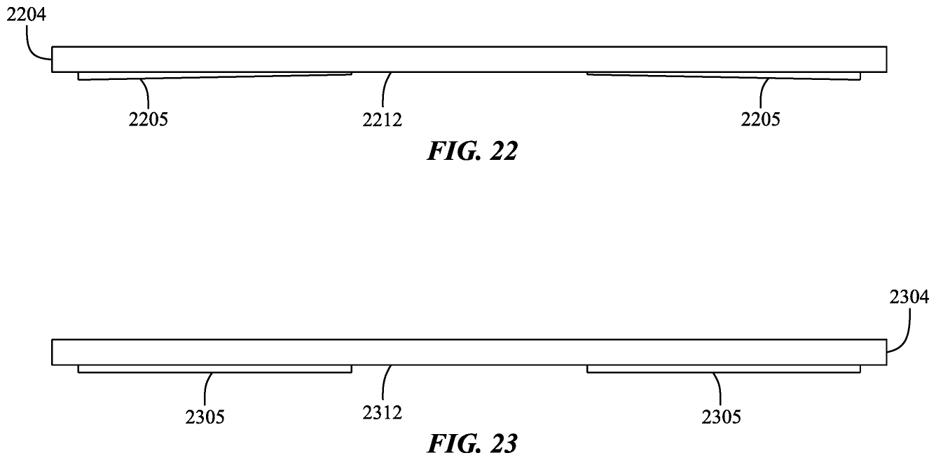

Any variety of shapes, sizes, positions, and quantity of deployable features can be constructed to deploy from the electronic device, as described herein. Various examples of the shapes, quantities, and positions of the deployable features, as described herein, are described below with reference to FIGS. 22-30. The electronic devices, base portions, and deployable features discussed in FIGS. 22-30 can be substantially similar to, and can include some or all of the features of any of the electronic devices, base portions, and deployable features described herein, and can further be deployed by any combination of the actuation components described herein.

FIG. 22 shows a rear view of a base portion 2204 of an electronic device. In some examples, a deployable feature 2205 can include two support structures or feet. The deployable features 2205 can extend at an angle from the bottom surface 2212 of the base portion 2204. For instance, a portion of the deployable feature 2205 proximate the sides or edges of the base portion 2204 can extend further away from the bottom surface 2212 than an inner portion of the deployable feature 2205, such that the deployable feature 2205 is tilted or angled relative to the bottom surface 2212 of the base portion 2204. FIG. 23 shows a rear view of a base portion 2304. In some examples, the deployable features 2305 of the base portion 2314 are not angled relative to the base portion 2304, and can be parallel with the bottom surface 2312 of the base portion 2304 when deployed.

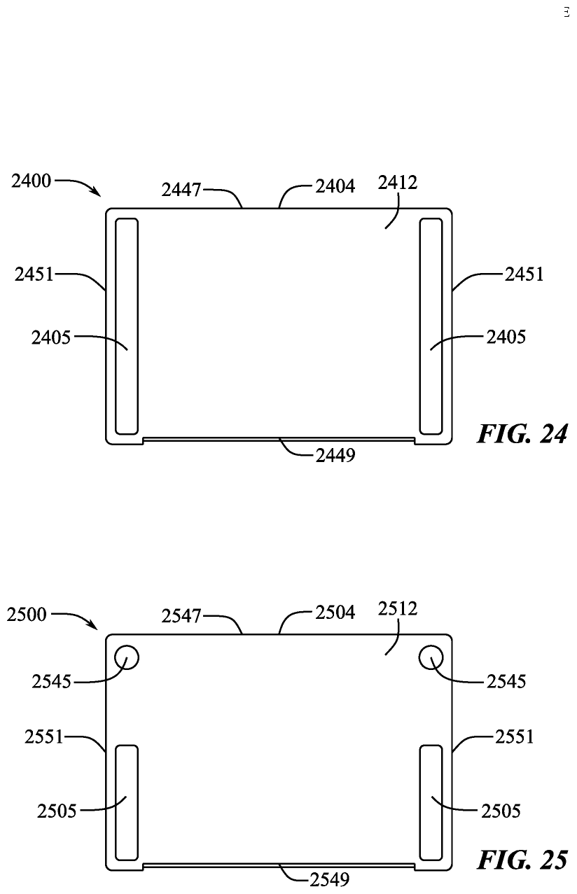

FIG. 24 shows a bottom view of a base portion 2404 of an electronic device 2400. In some examples, a base portion 2404 can include or define a front edge 2447 and a rear edge 2449 opposite the front edge 2447. The rear edge 2449 can be proximate a hinge or other assembly that is coupled to a display portion, for example, at an edge thereof. Further, the base portion 2404 can include side edges 2451 disposed between and connecting the front edge 2447 and the rear edge 2449 of the base portion 2404. As shown in FIG. 24, in some examples, the base portion 2404 can include two deployable features 2405 that can include feet or support structures. The feet 2405 can be positioned along or near the side edges 2451 of the bottom surface 2412 of the base portion 2404. In some examples, the feet 2405 can extend substantially all or, or a majority of the length of the side edges 2451 of the base portion 2404

FIG. 25 shows a bottom view of a base portion 2504 of an electronic device 2500. In some examples, deployable feature 2505 can include two feet that extend from a bottom surface 2512 and are positioned proximate a rear edge 2549 and along or parallel with side edges 2551 of the base portion 2504. Further, in some examples, the base portion 2504 can include additional fixed supports 2545 that can be disposed at any location, such as proximate the front edge 2547 of the base portion 2504. Thus, in some examples, the deployable features 2505 can extend less than an entire length of a side edge 2551 of the base portion 2504.

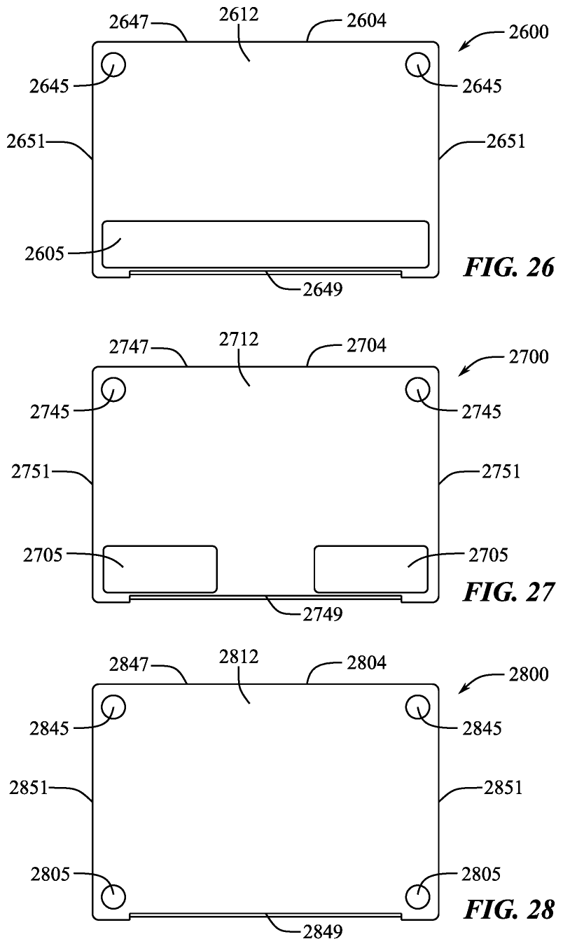

FIG. 26 shows a bottom view of an electronic device 2600 including a single deployable feature 2605 that is disposed on a bottom surface 2612 of the base portion 2604 and that runs along substantially all or a majority of the rear edge 2649 of the base portion 2604. In some examples, the deployable feature 2605 can be substantially parallel to the rear edge 2649. Further, the base portion 2604 can include fixed supports 2645 that can be disposed proximate the front edge 2647 of the base portion 2604 (and/or also proximate the side edges 2651).

FIG. 27 shows a bottom view of an electronic device 2700. Two deployable features 2705 are positioned on a bottom surface 2712 of a base portion 2704 and include feet that are positioned proximate a rear edge 2749 of the base portion 2704. In some examples, the base portion 2704 can further include fixed supports 2745 that can be proximate corners formed by the front edge 2747 and the sides edged 2751.

FIG. 28 shows a bottom view of an electronic device 2800. Two deployable features 2805 can include feet or support structures that are positioned proximate a rear edge 2849 and side edges 2851 of a base portion 2804. For example, the deployable features 2805 can be positioned in corners formed where the rear edge 2849 and the side edges 2851 meet. The base portion 2804 can further include other fixed feet or support structures 2845 disposed on the bottom surface 2812 and fixed proximate the front edge 2847 of the base portion 2804. In some examples, the deployable features 2805 can be substantially similar in structure, shape, and profile to the feet 2845 when in an un-deployed state. In some examples, the bottom surface 2812 can define or include features that can allow air to flow in and/or out of the internal volume of the electronic device 2800. In some examples, the bottom surface 2812 can define any number of holes, perforations, or other air-permeable features that can be disposed adjacent or near to any or all of the deployable features 2805 and/or support structures 2845. For example, the bottom surface can define a number of perforations that can be disposed near to, and surrounding one or more of the deployable features 2805 and/or support structures 2845. These perforations can allow air to flow in and/or out of the internal volume and can serve to enhance the amount of air flowing into and/or out of the internal volume in the same manner as any of the vents described herein.

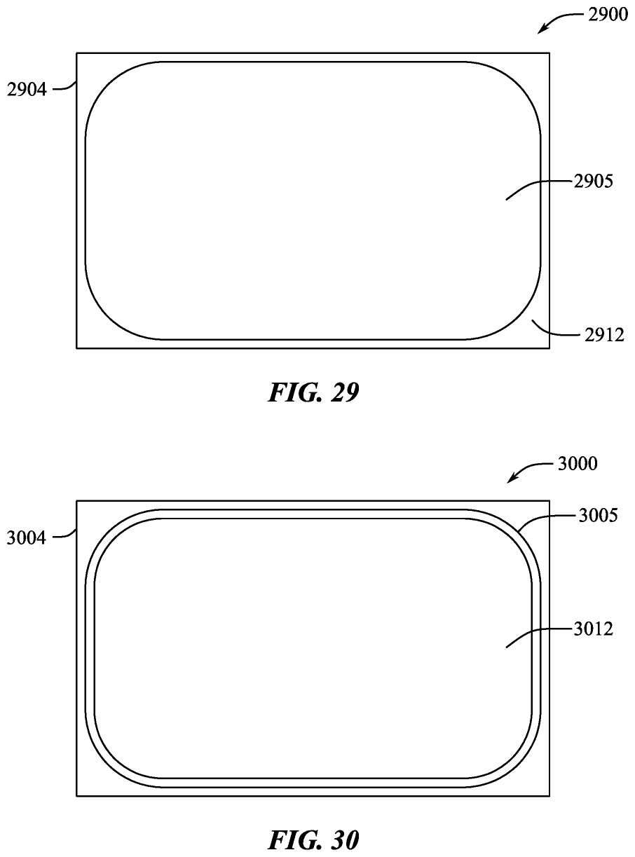

FIG. 29 shows a bottom view of an electronic device 2900 including a base portion 2904 and a deployable feature 2905. In some examples, a deployable feature 2905 is a bottom panel-like structure that can cover or define substantially all of a bottom surface 2912 of the base portion 2904. FIG. 30 shows a bottom view of an electronic device 3000 including a base portion 3004 and a deployable feature 3005. The deployable feature 3005 can be a ring or a rim that at least partially extends around and encompasses a region of a bottom surface 3012 of the base portion 3004. For example, the deployable feature 3005 can be disposed along a perimeter of the base portion 3004 and can have a shape or profile corresponding to the shape of the surface 3012, although other shapes and designs are expressly contemplated.

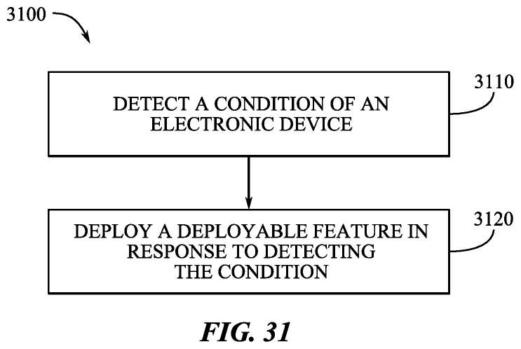

Any variety of configurations can be constructed to include a deployable feature, as described herein. Further, as discussed herein, the process for deploying a deployable feature from a base portion of an electronic device can include any combination of actuation components. Various examples of deployable features, as described herein, and functions of the same, are described below with reference to FIG. 31.

FIG. 31 shows a process flow diagram of a method for deploying deployable features of an electronic device, such as any of the deployable features and/or electronic devices described herein. According to the process 3100, a condition of the electronic device can detected, and in response to detecting the condition, the deployable feature can deployed. At block 3110, a condition of the electronic device is detected. In some examples, detecting the condition can include detecting an operational state of the electronic device, such as a temperature of the electronic device, a fan speed of the device, and/or a processor load or speed of the device. In some examples, detecting the condition can include detecting or receiving a signal from one or more components of the device. For example, a component such as a speaker or antenna can provide a signal when being used or when about to be used that can be detected by the device to initiate deployment of the deployable feature. In some examples, detecting the condition can include detecting an input from an input number of the electronic device, detecting a rotation or position of a portion or the device relative to one or more other portions, detecting a position of the device relative to a support surface, and/or other conditions as discussed above. For instance, the electronic device can have a threshold operating temperature and detecting the condition can include when a temperature of the device or a portion of the device is above the threshold operating temperature.

Further, the detecting the condition can include detecting a user input, for example, on an input member or component. For example, a user can push a button or select an input, such as an on/off switch, and detecting the condition can include detecting a signal that can be sent in response to the input. In some examples, the signal can be detected to initiate the actuation component to deploy the deployable feature or features. In some examples, detecting the condition can including detecting a rotation of the display portion relative to the base portion, indicating an open position of the electronic device. At block 3120, the deployable feature can be deployed in response to detecting the condition. The deployable feature can be deployed by any of the components and methods discussed herein, such as by one or more actuation components.

While the present disclosure generally describes deployable features and methods for their deployment from a portion of a device, the components, features, and methods described herein can be used in any combination or order and with any desired component, portion, or electronic device. Further, the components and features can assume any geometric shape, pattern, size, or combination of shapes, patterns, and sizes, and can be included in any number an in any position or combination of positions. Additionally, the deployable features and actuation components described herein can be positioned on or extend from any surface or surfaces of any desired housing and/or components.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

As used herein, the terms exterior, outer, interior, inner, top, bottom, upper, and lower are used for reference purposes only. An exterior or outer portion of a component can form a portion of an exterior surface of the component but may not necessarily form the entire exterior of outer surface thereof. Similarly, the interior or inner portion of a component can form or define an interior or inner portion of the component but can also form or define a portion of an exterior or outer surface of the component. A top portion of a component can be located above a bottom portion in some orientations of the component, but can also be located in line with, below, or in other spatial relationships with the bottom portion depending on the orientation of the component.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. An electronic device comprising:
a base portion defining an internal volume;
a display portion rotatably mounted to the base portion;
a deployable feature coupled to the base portion, the deployable feature extending from a surface of the base portion when deployed, the deployable feature defining a vent that provides fluid communication between the internal volume and an ambient environment when the deployable feature is deployed and undeployed; and
an actuation component coupled to the deployable feature.

2. The electronic device of claim 1, wherein:
the base portion comprises a portion of a housing of the electronic device;
the surface is a first surface and the base portion further defines a second surface opposite the first surface;
the deployable feature is positioned at the first surface; and
the base portion further comprises a keyboard positioned at the second surface.

3. The electronic device of claim 1, wherein an opening in communication with the internal volume defined by the base portion enlarges when the deployable feature is deployed.

4. The electronic device of claim 3, wherein the deployable feature at least partially defines an air volume when deployed.

5. The electronic device of claim 4, wherein the air volume is usable by an antenna or a speaker.

6. The electronic device of claim 1, wherein rotating the display portion relative to the base portion actuates the actuation component to deploy the deployable feature.

7. The electronic device of claim 1, wherein the actuation component comprises a gear train.

8. The electronic device of claim 1, wherein the deployable feature is manually deployable.

9. (canceled)

10. The electronic device of claim 1, further comprising a sensor that generates a signal when the deployable feature is deployed.

11. The electronic device of claim 1, wherein the actuation component comprises at least one of a pneumatic system, a magnetic system, a piezo friction system, or an electro-mechanical system.

12. The electronic device of claim 1, wherein the deployable feature comprises a support structure that extends at least 3 millimeters (mm) from the surface when deployed.

13. A method for deploying a deployable feature of an electronic device, comprising:
detecting a condition of the electronic device; and
deploying the deployable feature in response to detecting the condition.

14. The method of claim 13, wherein detecting the condition comprises receiving an input from an input member of the electronic device.

15. The method of claim 13, wherein detecting the condition comprises detecting a rotation of a display portion of the electronic device relative to a base portion of the electronic device.

16. The method of claim 13, wherein deploying the deployable feature comprises extending the deployable feature a distance from a base portion of the electronic device.

17. An electronic device comprising:
a base portion comprising a deployable feature; and
a display portion moveably affixed to the base portion;
the deployable feature being deployable from the base portion in response to a signal.

18. The electronic device of claim 17, wherein the deployable feature deploys vertically relative to the base portion.

19. The electronic device of claim 17, further comprising a sensor that detects at least one of a temperature or a processing speed of the electronic device and provides the signal in response to the detection.

20. The electronic device of claim 17, further comprising:
a fan;
wherein a speed of the fan is at least partially determined based on a state of the deployable feature.
